(19) United States
(12) Patent Application Publication
(10) Pub. No.: US 2006/0031604 A1
(43) Pub. Date: Feb. 9, 2006

(54) DMA transfer apparatus and method of controlling data transfer

(75) Inventors: Norifumi Fukawa, Kawasaki (JP); Hidetaka Ebeshu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/011,072

(22) Filed: Dec. 15, 2004

(30) Foreign Application Priority Data
Aug. 9, 2004 (JP) 2004-232294

(51) Int. Cl. G06F 13/28

(52) U.S. Cl. 710/22

(57) ABSTRACT

A direct-memory-access transfer apparatus includes an information reading unit that reads transfer-count information from a memory before starting data transfer prior to transferring data stored in the memory; a data transferring unit that transfers the data stored in the memory; and a transfer controlling unit that controls, when the information reading unit reads transfer-count information, the data transferring unit to transfer the data stored in the memory.

### CROSS-REFERENCE TO RELATED APPLICATIONS

This application is based upon and claims the benefit of priority from the prior Japanese Patent Application No. 2004-232294, filed on Aug. 9, 2004, the entire contents of which are incorporated herein by reference.

### BACKGROUND OF THE INVENTION

1) Field of the Invention

The present invention relates to a direct-memory-access (DMA) transfer apparatus that transfers data stored in a memory to other apparatus, and a method of controlling data transfer for the DMA transfer apparatus.

2) Description of the Related Art

A DMA transfer apparatus is frequently used in computers and computer control apparatus. The DMA transfer apparatus is an apparatus to transfer data stored in a memory directly to other memories and the like. A central processing unit (CPU) not only computes data but also sometimes transfers data, and this processing burden on the CPU can be reduced by using DMA. Provision of registers inside the DMA transfer apparatus makes it possible to set a transfer count and transfer data by the set count without mediating a CPU. An operation of the DMA transfer apparatus and problems caused by the operation are explained with the use of FIGS. 1 and 2.

FIG. 1 is an explanatory diagram to represent an example of a data transfer by a conventional DMA transfer apparatus. A CPU 610, a first-in first-out (FIFO) memory 620, and a DMA transfer apparatus 630 are connected to one another via a bus 640, and the right for the bus of the bus 640 is managed by a bus arbiter 650. The FIFO 620 is composed of an effective byte count register 621 and a store area 622. The store area 622 is divided into blocks 623, 624, 625, etc., and the DMA transfer apparatus 630 includes a DMA transfer count register 631.

First, the CPU 610 reads in transfer-count data from the effective byte count register 621 in the FIFO 620 (660). The CPU 610 writes the read transfer-count data to the DMA transfer count register 631 of the DMA transfer apparatus 630 (670). Then, the DMA transfer apparatus 630 reads in the transfer-count data and initiates DMA transfer from the store area 622.

FIG. 2 is a flowchart of a process procedure of conventional DMA transfer. Prior to the transfer initiation, the CPU 610 reads in the DMA transfer count from the effective byte count register 621 of the FIFO 620 (step S701). Next, the CPU 610 writes the read DMA transfer count to the DMA transfer count register 631 inside the DMA transfer apparatus 630 (step S702). Next, the DMA transfer apparatus 630 reads in the DMA transfer count written to the DMA transfer count register 631 immediately before transfer, followed by initiating the DMA transfer.

Here, the DMA transfer apparatus 630 sends an interrupt request to the CPU 610 (step S703). The DMA transfer apparatus 630 waits until an enabling signal from the CPU 610 becomes “1”, and then moves to the next processing (step S704). When the enabling signal from the CPU 610 becomes “1” (‘YES’ at step S704), the DMA transfer apparatus 630 judges whether a STOP request is made inside (step S705). When the STOP request is made (‘YES’ at step S705), the DMA transfer apparatus 630 judges whether the STOP enabling signal is “1” (step S706). When the STOP request is made and when the STOP enabling signal is “1” (‘YES’ at step S706), this indicates that a request to halt the DMA processing is made. Therefore, the DMA transfer apparatus 630 terminates the DMA transfer processing, and the bus arbiter 650 passes the right for the bus to the CPU 610.

When a STOP request is not made (‘NO’ at step S706), or when no STOP enabling signal is input even when the STOP request is made (‘NO’ at step S706), the DMA transfer apparatus 630 returns to the DMA transfer processing. At this time, the bus arbiter 650 moves the right for the bus from the CPU 610 to the DMA transfer apparatus 630. At this point, the DMA transfer apparatus 630 reads out the DMA transfer-count data from the DMA transfer count register 631 (step S707). When the transfer-count data is written, the DMA transfer processing is carried out (step S708).

When one data transfer is completed, the transfer count written to the DMA transfer count register 631 is reduced by one (step S709). Then, the DMA transfer apparatus 630 judges whether the transfer count becomes zero (step S710). When the transfer count becomes zero (‘YES’ at step S710), the DMA transfer apparatus 630 terminates the processing.

When the count of the transfer-count data is not zero (‘NO’ at step S710), this indicates that data to be transferred remains in the FIFO 620; therefore, the DMA transfer apparatus 630 returns to DMA transfer processing. At this time, the DMA transfer apparatus 630 judges whether a STOP request is made inside (step S711). When a STOP request is made (‘YES’ at step S711), the DMA transfer apparatus 630 judges whether the STOP enabling signal is “1” (step S712). When a STOP request is made and the STOP enabling signal is “1” (‘YES’ at step S712), this indicates that a request to halt the DMA processing is made; therefore, the DMA transfer processing is terminated. The bus arbiter 650 passes the right for the bus to the CPU 610. When a STOP request is not made (‘NO’ at step S711), or when the STOP enabling signal is not “1” even when the STOP request is made (‘NO’ at step S712), the DMA transfer apparatus 630 proceeds to the step S708 and returns to DMA transfer processing.

Further, a technology with which DMA activation without the use of a processor and DMA activation condition control are realized has existed. With this technology, a DMA controller monitors the amount of data of the input/output (I/O) at all times and compares it with a threshold value, and the right for the bus request is made to the bus master of the bus in which the I/O is present in the transfer end under the condition that the amount of data corresponds to the threshold value, followed by carrying out DMA transfer after obtaining the right for the bus. The DMA and FIFO are constructed in the same I/O. Accordingly, when a certain amount of data is received from the network and accumulated in the FIFO, the DMA is activated without mediating a CPU, and the data received is sent to the bus by the DMA transfer (see, for example, Japanese Patent Application Laid-Open Publication No. 1995-114510).

However, in conventional setting for the DMA transfer count, the CPU 610 reads in the effective byte count register 621 of the FIFO 620 once and writes the transfer-count data to the DMA transfer count register 631, and then the DMA transfer apparatus 630 reads out the data written, followed by carrying out DMA transfer. Therefore, this gives rise to a burden on the processing of the CPU 610, and it takes time before transfer initiation.

Setting of the DMA transfer count proceeds in steps; the CPU 610 reads in transfer-count data from the FIFO 620; the CPU 610 writes it to the DMA transfer count register 631; and the DMA transfer apparatus 630 reads out the data from the DMA transfer count register 631. Because of these steps, it takes time before DMA transfer initiation, and moreover, a burden has been put on the processing of the CPU 610. This procedure has always been preformed at the time of carrying out DMA transfer.

### SUMMARY OF THE INVENTION

It is an object of the present invention to solve at least the above problems in the conventional technology.

A direct-memory-access transfer apparatus according to one aspect of the present invention includes an information reading unit that reads transfer-count information from a memory before starting data transfer prior to transferring data stored in the memory; a data transferring unit that transfers the data stored in the memory; and a transfer controlling unit that controls, when the information reading unit reads transfer-count information, the data transferring unit to transfer the data stored in the memory.

A direct-memory-access transfer apparatus according to another aspect of the present invention includes a signal receiving unit that receives, from a memory, an enabling signal relating to presence or absence of data to be stored in the memory; a data transferring unit that transfers the data stored in the memory; and a transfer controlling unit that controls, while the signal receiving unit receives the enabling signal, the data transferring unit to transfer the data stored in the memory.

A method of controlling data transfer according to still another aspect of the present invention includes reading transfer-count information from a memory before starting data transfer; and instructing, when the transfer-count information is read at the reading, to transfer data stored in the memory.

A method of controlling data transfer according to still another aspect of the present invention includes receiving, from a memory, an enabling signal relating to presence or absence of data to be stored in the memory; and instructing, while the enabling signal is received at the receiving, to transfer data stored in the memory.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram to represent an example of data transfer by a conventional DMA transfer apparatus;

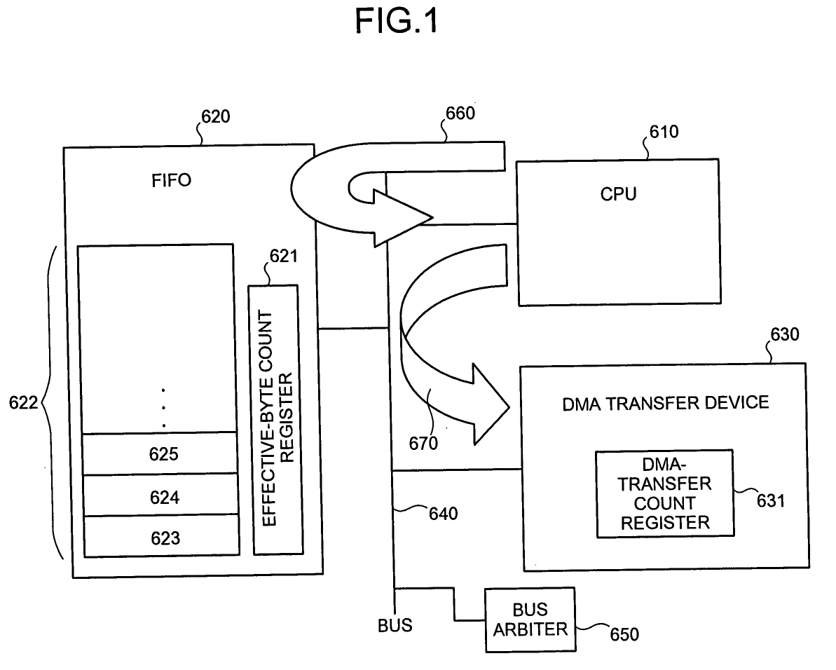

FIG. 2 is a flowchart to represent processing procedures of conventional DMA transfer;

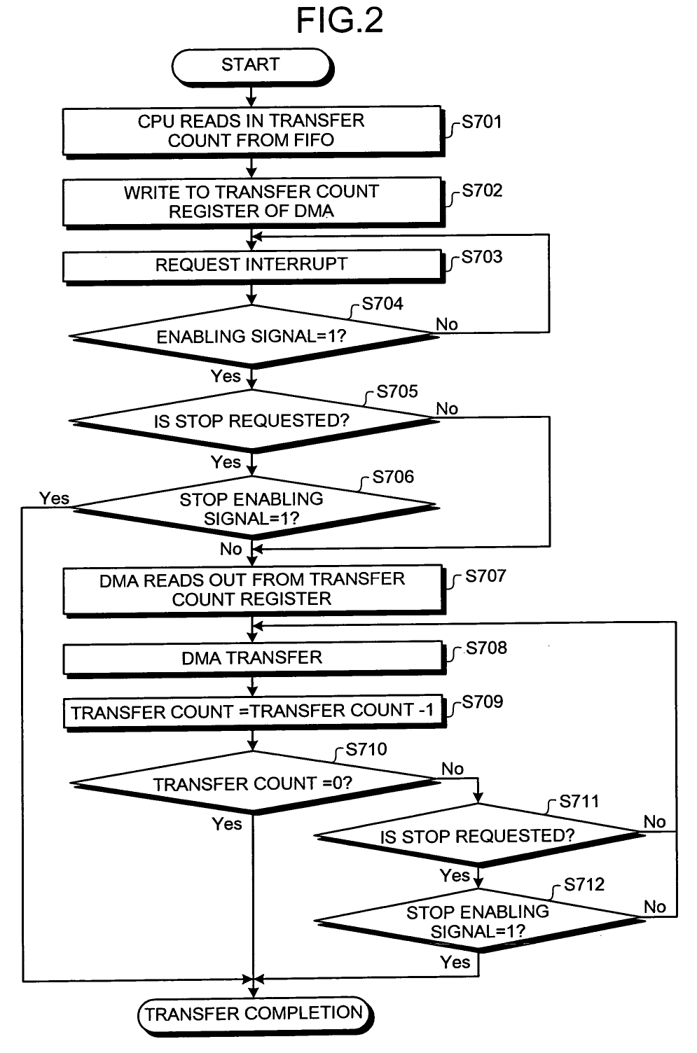

FIG. 3 is a block diagram to represent a hardware structure of a DMA processing apparatus;

FIG. 4 is a structural block diagram to explain a FIFO in detail;

FIG. 5 is a flowchart to represent an operation of a DMA processing apparatus according to a first embodiment of the present invention;

FIG. 6 is a block diagram to represent a hardware structure of a DMA processing apparatus according to a second embodiment of the present invention;

FIG. 7 is a flowchart to represent an operation of the DMA processing apparatus according to the second embodiment; and

FIG. 8 is a block diagram to represent a functional structure of a DMA transfer apparatus according to the present invention.

### DETAILED DESCRIPTION

Exemplary embodiments of a DMA transfer apparatus and a method of controlling data transfer for the DMA transfer apparatus according to the present invention will be explained in detail with reference to the accompanying drawings.

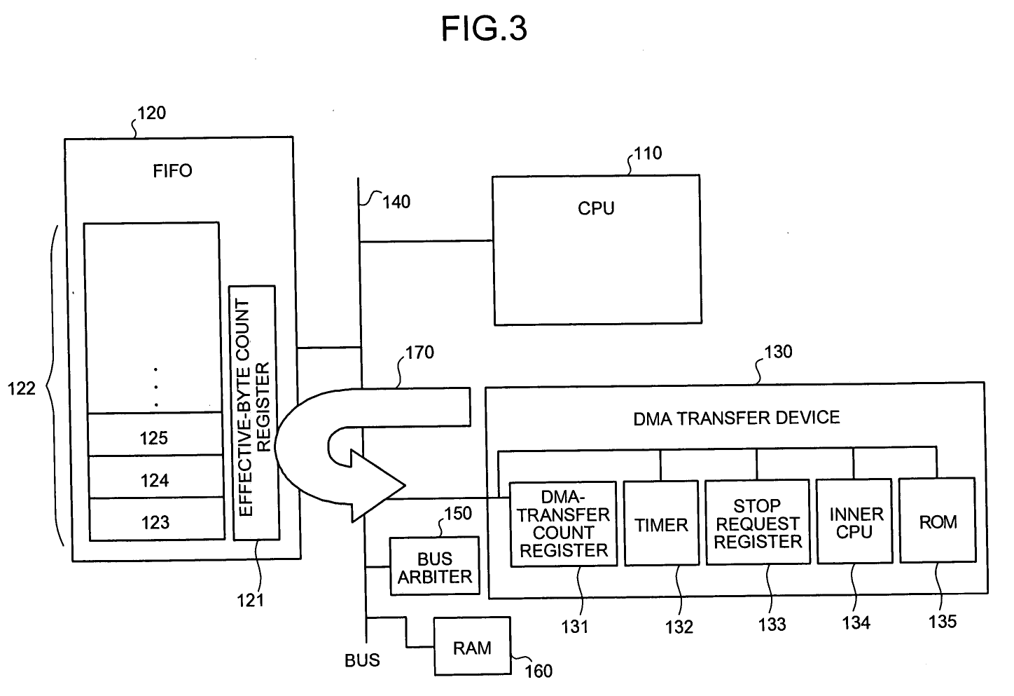

FIG. 3 is a block diagram to represent a hardware structure of a DMA processing apparatus. A CPU 110 is a processor that controls a processing operation of the whole system and carries out computation and the like. A FIFO 120 is a first-in first-out system and is also a memory that stores data the FIFO 120 receives in an orderly manner and that reads out the data from the data stored first.

The FIFO 120 includes an effective byte count register 121 and a store area 122. The effective byte count register 121 stores transfer-count data. The store area 122 is an area in which data is stored and is divided into blocks 123, 124, 125, etc. A DMA transfer apparatus 130 carries out DMA transfer of data stored in the FIFO 120.

The DMA transfer apparatus 130 includes a DMA transfer count register 131, a timer 132, a STOP request register 133, an inner CPU 134, and a read only memory (ROM) 135. The DMA transfer count register 131 is a register to store transfer-count data that is an execution count that the DMA transfer apparatus 130 carries out data transfer. At the time when the DMA transfer apparatus 130 transfers data once, the DMA transfer count register 131 transfers the next data to be stored when the count is not zero and is reduced by one from the count of transfer-count data, and when it becomes zero, the DMA transfer apparatus 130 terminates the data transfer.

The timer 132 counts elapsed time after the right for the bus has been passed to the DMA transfer apparatus 130, stops the processing by the DMA transfer apparatus 130 after a specified time passes, and releases the right for the bus. The STOP request register 133 is a register to set a STOP flag when data transfer by the DMA transfer apparatus 130 is completed, and is used for passing the use right of the bus by reading out the flag with a bus arbiter 150 described later. The operation of the DMA transfer apparatus 130 in the foregoing is carried out by reading out a program from the ROM 135 with the inner CPU 134.

The CPU 110, the FIFO 120, and the DMA transfer apparatus 130 are connected to one another via a bus 140, and sending and receiving data, and instructing control operation are carried out via the bus 140. The use right of the bus 140 is occupied by a specific processing unit; however, this right for the bus is controlled by the bus arbiter 150. A random access memory (RAM) 160 is connected to the bus 140. Data read out by the DMA transfer apparatus 130 from the FIFO 120 is transferred to the RAM 160.

With the use of the above structure, an operation of the whole DMA processing apparatus is explained. The DMA transfer apparatus 130 reads in data from the effective byte count register 121 of the FIFO 120, and writes the read data to the DMA transfer count register 131 of the DMA transfer apparatus 130 as DMA transfer-count data (170). Conventionally, a CPU reads in an effective byte count register of FIFO and writes the read count to a DMA transfer count register. However, the DMA transfer apparatus 130 reads in the data of the effective byte count register 121 of the FIFO 120 as the transfer-count data before transfer initiation, and writes the read data to the DMA transfer count register 131 of the DMA transfer apparatus 130. This makes the number of cycles before the transfer initiation smaller than before.

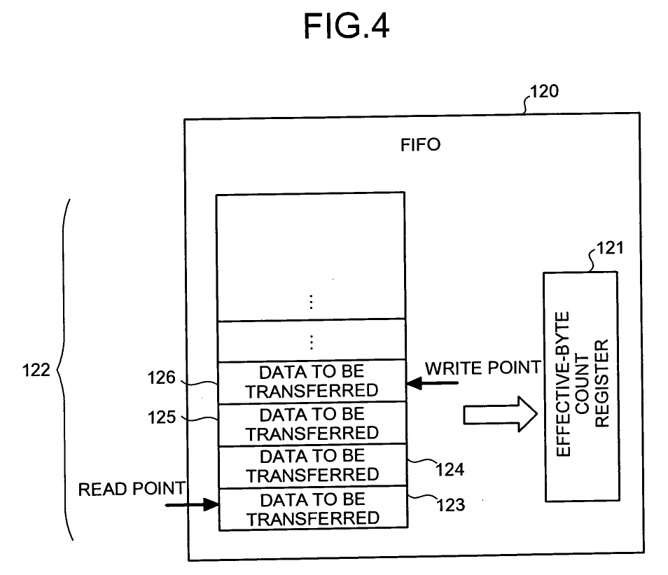

FIG. 4 is a structural diagram to explain the FIFO 120 in detail. The FIFO 120 stores transfer data from 123 to 126. Here, the read point indicates 123 and the write point indicates 126. The read point and the write point are both specified by pointers respectively. The difference between the write point and the read point indicated by the pointers is an effective byte count. The effective byte count is written to the effective byte count register 121 as the transfer-count data.

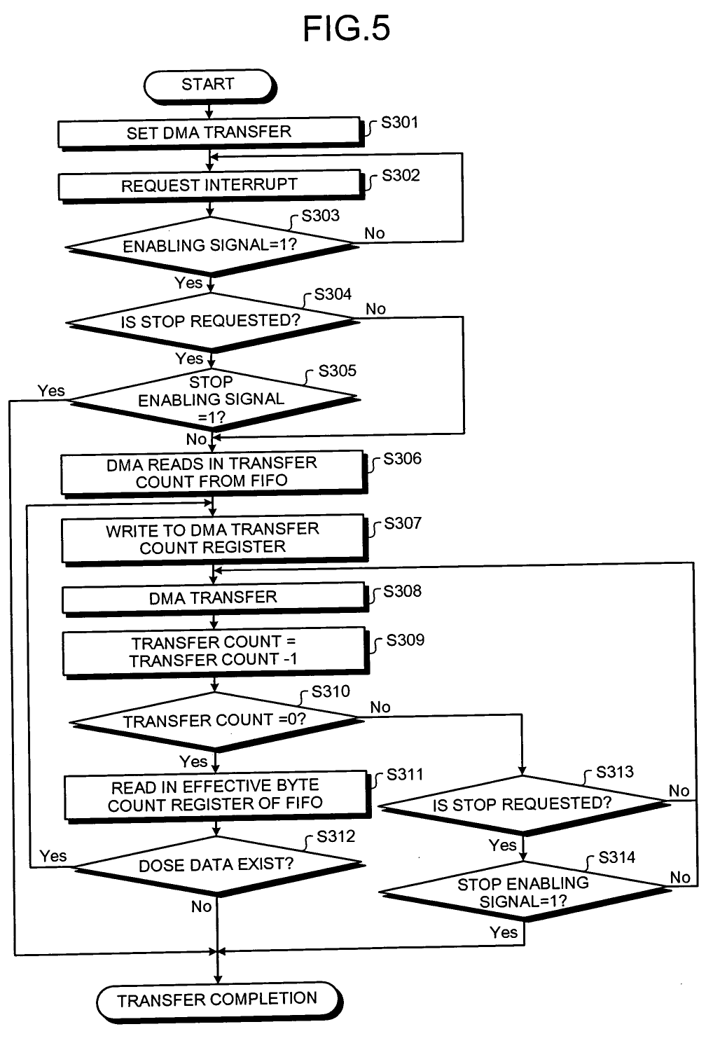

FIG. 5 is a flowchart to represent an operation of DMA processing apparatus in a first embodiment of the present invention. First, setting of DMA transfer is carried out (step S301). Next, the DMA transfer apparatus 130 sends an interrupt request to the CPU 110 (step S302). The DMA transfer apparatus 130 waits until an enabling signal from the CPU 110 becomes “1”, followed by moving to the next processing (step S303). When the enabling signal from the CPU 110 is “1” (‘YES’ at step S303), the DMA transfer apparatus 130 judges whether a STOP request is written to the inner STOP request register 133 (step S304).

When a STOP request is written (step S304; Yes), the DMA transfer apparatus 130 judges whether the STOP enabling signal is “1” (step S305). When the STOP enabling signal is “1” (‘YES’ at step S305), it indicates that a request to halt the DMA processing has been made; therefore, the DMA transfer processing is terminated, and the bus arbiter 150 passes the right for the bus to the CPU 110.

When a STOP request is not made (‘NO’ at step S304), or when the STOP enabling signal is zero even when the STOP request is made (‘NO’ at step S305), the bus arbiter 150 passes the right for the bus from the CPU 110 to the DMA transfer apparatus 130, and then the DMA transfer apparatus 130 reads in transfer-count data from the effective byte count register 121 in the FIFO 120 (step S306) and writes the data to the DMA transfer count register 131 (step S307).

In other words, the DMA transfer apparatus 130 reads in the transfer-count data of the effective byte count register 121 of the FIFO 120 as the transfer count of the DMA transfer apparatus 130 before data transfer initiation, and then writes the data to the DMA transfer count register 131 in stead of reading out the written transfer-count data with the DMA transfer apparatus 130 after the CPU 110 has written the transfer-count data to the DMA transfer count register 131 of the DMA transfer apparatus 130.

When the transfer-count data is written, the DMA transfer processing is carried out (step S308). The DMA transfer apparatus 130 reads out the data from the store area 122. Assume that the data to be read out is the data of a block 123 indicated by the read point. When the data is read out, the data of the block 123 is deleted, and the read point is moved to 124. The data read out is transferred to the RAM 160 via the bus 140.

When one data transfer is completed, the count written to the DMA transfer count register 131 is reduced by one (step S309). This data transfer is structured so as to reduce the transfer count after DMA transfer is carried out; however, a structure where DMA transfer is carried out after reduction of the transfer count may also be applied. Then, whether the transfer count has become zero is judged (step S310). When the transfer count has become zero (‘YES’ at step S310), the DMA transfer apparatus 130 reads in the transfer-count data in the effective byte count register 121 (step S311), and judges whether transfer-count data exists (step S312). When the transfer-count data exists in the effective byte count register 121 (‘YES’ at step S312), the DMA transfer apparatus 130 returns to the step S307 again, and writes the DMA transfer-count data to the DMA transfer count register 131.

Originally, processing of writing the transfer-count data is passed to the CPU 110 at the time of completion of data transfer by the DMA transfer apparatus 130 and is initiated again upon receiving a transfer instruction from the CPU 110. However, its processing is carried out without returning to the CPU 110 in the present embodiment. DMA transfer is thus initiated, which makes the burden on the CPU 110 lessened. When writing of transfer-count data is executed, the operation of the DMA transfer processing described above is repeated. When no transfer-count data exists in the effective byte count register 121, transfer processing is terminated, and the bus arbiter 150 passes the right for the bus to the CPU 110.

When the count of the transfer-count data is not zero (‘NO’ at step S310), it indicates that data to be transferred still remains in the FIFO 120, therefore, returning to the DMA transfer processing. At this point, the DMA transfer apparatus 130 judges whether a STOP request is written to the inner STOP request register 133 (step S313). When a STOP request is written (‘YES’ at step S313), the DMA transfer apparatus 130 judges whether the STOP enabling signal is “1” (step S314). When the STOP enabling signal is “1” (‘YES’ at step S314), it indicates that a request to halt the DMA processing is made. Therefore, the DMA transfer processing is terminated, and the bus arbiter 150 passes the right for the bus to the CPU 110. When a STOP request is not made (‘NO’ at step S313), or when the STOP enabling signal is zero even when the STOP request is made (‘NO’ at step S314), the DMA transfer apparatus 130 moves to the step S308 and shifts to the DMA transfer processing.

A STOP request at the respective step S304 and step S313 is explained. This STOP request is made when processing with high priority is carried out in the CPU 110, causing an interrupt to occur, or when an error occurs. A STOP request can also be made to suspend the DMA transfer processing temporally when the timer 132 passes a specified time. The timer 132 initiates counting at the time of confirmation of initiation of the DMA transfer processing after an interrupt request is made by the DMA transfer apparatus 130 at the step S302 and then the enabling signal is confirmed to be “1”.

When the timer 132 counts the count value set in advance, the DMA transfer apparatus 130 makes a STOP request and suspends the DMA transfer processing after carrying out judgment processing of the presence or absence of the STOP request at the step S304 and the step S313, respectively, followed by passing processing to the CPU 110. It is possible to resume the suspended DMA transfer processing. Since the transfer-count data remains in the effective byte count register 121, the DMA transfer processing can be resumed by reading out the transfer-count data again when the CPU 110 completes the processing and when the DMA transfer apparatus 130 gets the right for the bus again. In this way, it is possible to prevent DMA transfer from being continued as long as the data exists in the effective byte count register 121.

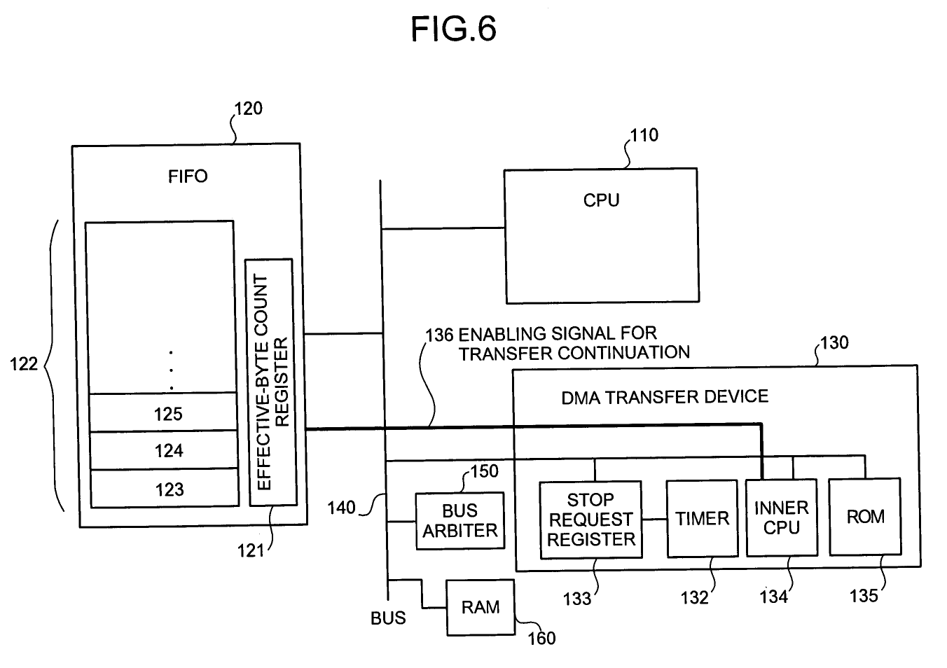

According to the first embodiment, DMA transfer is controlled via the DMA transfer count register 131. However, in a second embodiment of the present invention, an example in which DMA transfer is controlled without the use of the DMA transfer register 131 is explained. FIG. 6 is a block diagram of a hardware structure of the DMA processing apparatus according to the second embodiment. The functional structures of the CPU 110 and the FIFO 120 are the same as those according to the first embodiment. As long as the effective byte count register 121 does not become zero, the FIFO 120 outputs enabling signals of transfer continuation 136 to the DMA transfer apparatus 130. The structure is designed such that the enabling signals of transfer continuation 136 to the DMA transfer apparatus 130 are interrupted when the effective byte count register 121 becomes zero.

The DMA transfer apparatus 130 always reads in the FIFO 120 at the time of DMA transfer, and keeps on transferring data stored in the store area 122 to the RAM 160 as long as the effective byte count register 121 does not become zero. The DMA transfer apparatus 130 according to the second embodiment does not require the DMA transfer count register 131, which is different from the first embodiment. This is because the FIFO 120 outputs the enabling signals of transfer continuation 136 to the DMA transfer apparatus 130 at all times. The enabling signals of transfer continuation 136 can be detected at specified time intervals. Similarly to the first embodiment, the timer 132 counts elapsed time after the right for the bus is passed to the DMA transfer apparatus 130, halts the processing by the DMA transfer apparatus 130 after a specified time has passed, and then releases the right for the bus.

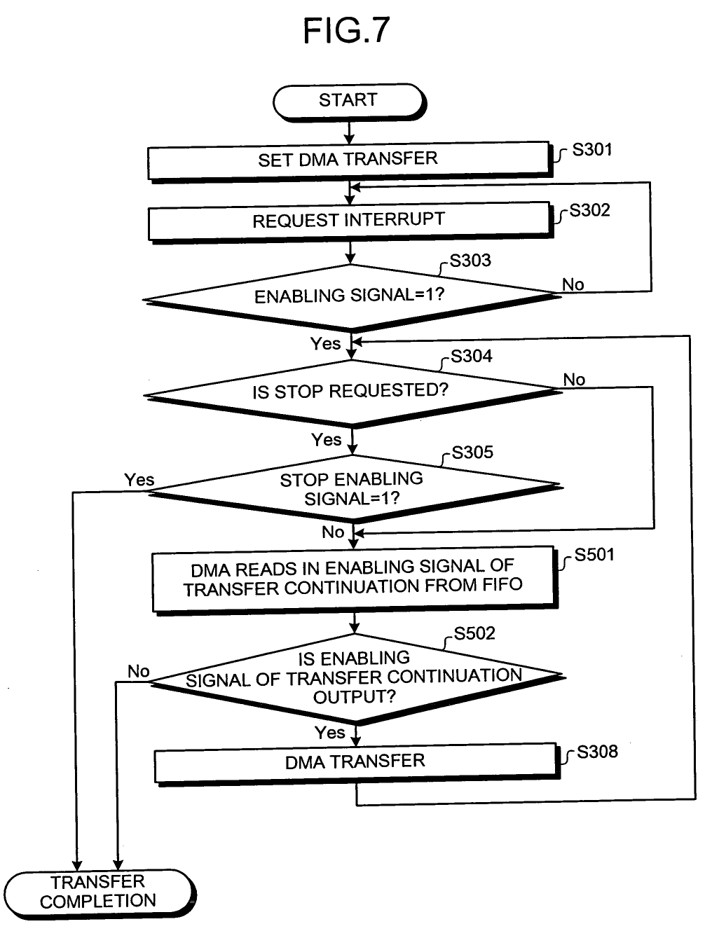

FIG. 7 is a flowchart to represent an operation of the DMA processing apparatus according to the second embodiment. The processing at the steps from S301 to S305 and the step S308 is the same as that according to the first embodiment. When a STOP request is not made at the step S304 and the step S305 (‘NO’ at step S304), or when the STOP enabling signal is zero even when the STOP request is made (‘NO’ at step S305), the bus arbiter 150 passes the right for the bus from the CPU 110 to the DMA transfer apparatus 130, and the DMA transfer apparatus 130 reads in the enabling signals of transfer continuation 136 (step S501).

Next, the DMA transfer apparatus 130 judges whether the enabling signals of transfer continuation 136 are output (step S502). When they are not output (‘NO’ at step S502), the processing is terminated. When the enabling signals of transfer continuation 136 are output (‘YES’ at step S502), the DMA transfer processing is carried out (step S308).

In the DMA transfer processing, the DMA transfer apparatus 130 read out data from the store area 122. Assume that the data to be read out is the data that is indicated by the read point in the block 123. When the data is read out, the data in the block 123 is deleted, and the read point is moved to 124. The data read out is transferred to the RAM 160 via the bus 140. When one data transfer is completed, the DMA transfer apparatus 130 returns to the step S304 again.

Due to the structure described above, setting of the transfer count becomes unnecessary, and the transfer is continued while the enabling signals of transfer continuation are “1”. Therefore, the number of cycles before the transfer is initiated is smaller, which can also reduce the burden on the CPU, compared with conventional DMA transfer.

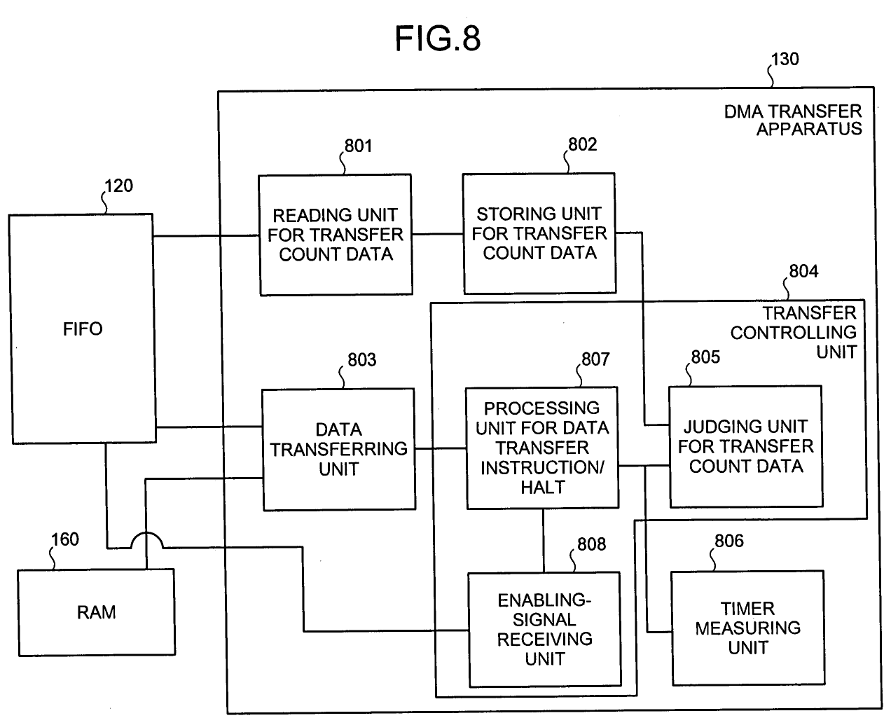

FIG. 8 is a block diagram to represent a functional structure of the DMA transfer apparatus of the present invention. A reading unit for transfer-count data 801 is a functioning unit that reads out transfer-count data from the effective byte count register 121 (see FIG. 3). The transfer-count data is an effective byte count that is a difference between the read point and the write point as described above. The reading unit for transfer-count data 801 reads out the effective byte count as the transfer-count data. A storing unit for transfer-count data 802 is a store area that stores the transfer-count data read out by the reading unit for transfer-count data 801.

A data transferring unit 803 is a functioning unit that transfers data from the FIFO 120 to the RAM 160. A transfer controlling unit 804 is a functioning unit that allows the data transferring unit 803 to transfer data and terminate data transfer. The transfer controlling unit 804 is composed of a judging unit for transfer-count data 805, a processing unit for data transfer instruction/halt 807, and an enabling signal receiving unit 808.

The judging unit for transfer-count data 805 is a functioning unit that reduces the transfer count shown in the transfer-count data and judges whether the resulting transfer count stored in the storing unit for transfer-count data 802 becomes zero. When the transfer count is zero, the judging unit for transfer-count data 805 terminates the data transfer processing by the data transferring unit 803, and instructs the reading unit for transfer-count data 801 to read out the transfer-count data again.

A timer measuring unit 806 is a functioning unit that initiates counting at the time when the data transferring unit 803 initiates data transfer and resets to zero at the time of termination of the data transfer. The processing unit for data transfer instruction/halt 807 is a functioning unit that terminates data transfer processing by the data transferring unit 803 when the count measured by the timer measuring unit 806 reaches the predetermined value, or when it is judged that termination of the processing by the DMA transfer apparatus 130 (see FIG. 3) is appropriate at the time of an error occurrence and the like. The enabling signal receiving unit 808 is a function block to receive the enabling signals of transfer continuation 136 according to the second embodiment, and instructs continuation and termination of data transfer to the processing unit for data transfer instruction/halt 807 in accordance with authorization/unauthorization of transfer continuation indicated by the enabling signals of transfer continuation 136 (see FIG. 6).

According to the embodiments described in the foregoing, transfer-count data can be read in DMA prior to DMA transfer initiation, and returning the processing to the CPU upon the DMA transfer initiation becomes unnecessary. Therefore, the cycles before transfer initiation can be shorten and the burden on the CPU can be reduced, compared with conventional DMA. Further, the DMA transfer apparatus can keep on transfer continuously without releasing temporarily the right for the bus, which allows not only passing and receiving of the bus to be omitted but also DMA transfer to be carried out efficiently

According to the second embodiment, in particular, a register to store the DMA transfer count inside the DMA transfer apparatus becomes unnecessary. Therefore, reading and writing to the register become further unnecessary, which makes it possible to shorten the cycles before the DMA transfer initiation.

Furthermore, according to the embodiment in which the timer 132 is used, it is possible to avoid affecting operations of other resources by retaining the right for the bus due to transfer continuation by the DMA transfer apparatus as long as data exists in the memory, and to return the right for the bus without carrying out DMA transfer after a specified time has passed even when data exists in the memory so as not to keep possessing the bus.

A transfer control method for the DMA transfer apparatus that has been explained in the present embodiments can be realized by executing, by a computer, a program that is prepared in advance. This program is recorded in a recording medium that can be read by a computer such as a read only memory (ROM) and a hard disk, and is executed, by a computer, by reading out from a recording medium.

According to the present invention, an effect that the bus can be used effectively by shortening the cycles before transfer initiation and reducing the burden on the CPU compared with conventional DMA transfer is offered.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A direct-memory-access transfer apparatus comprising:
an information reading unit that reads transfer-count information from a memory before starting data transfer prior to transferring data stored in the memory;
a data transferring unit that transfers the data stored in the memory; and
a transfer controlling unit that controls, when the information reading unit reads transfer-count information, the data transferring unit to transfer the data stored in the memory.

2. The direct-memory-access transfer apparatus according to claim 1, wherein the transfer controlling unit includes a transfer-count determining unit that determines whether a count number in the transfer-count information is equal to or less than a predetermined number, and controls the data transferring unit based on a result of determination.

3. The direct-memory-access transfer apparatus according to claim 1, wherein the information reading unit reads, after the data has been transferred, current transfer-count information of the data from the memory based on the transfer-count information before the data transfer and the transfer-count information of the data transferred by the data transferring unit.

4. The direct-memory-access transfer apparatus according to claim 1, further comprising a time measuring unit that measures transfer time of the data, wherein
the transfer controlling unit controls, when the transfer time measured by the time measuring unit reaches a predetermined time, the data transferring unit to stop transferring the data stored in the memory.

5. A direct-memory-access transfer apparatus comprising:
a signal receiving unit that receives, from a memory, an enabling signal relating to presence or absence of data to be stored in the memory;
a data transferring unit that transfers the data stored in the memory; and
a transfer controlling unit that controls, while the signal receiving unit receives the enabling signal, the data transferring unit to transfer the data stored in the memory.

6. The direct-memory-access transfer apparatus according to claim 5, further comprising a time measuring unit that measures transfer time of the data, wherein
the transfer controlling unit controls, when the transfer time measured by the time measuring unit reaches a predetermined time, the data transferring unit to stop transferring the data stored in the memory.

7. A method of controlling data transfer for a direct-memory-access transfer apparatus that transfers data stored in a memory to other apparatus, the method comprising:
reading transfer-count information from the memory before starting the data transfer; and
instructing, when the transfer-count information is read at the reading, to transfer the data stored in the memory.

8. The transfer control method according to claim 7, wherein the instructing includes
determining whether a count number in the transfer-count information is equal to or less than a predetermined number; and
instructing to transfer the data stored in the memory based on a result of determination.

9. The transfer control method according to claim 7, wherein the reading includes reading, after the data has been transferred, current transfer-count information of the data from the memory based on the transfer-count information before the data transfer and the transfer-count information of the data transferred.

10. The transfer control method according to claim 7, further comprising:
measuring transfer time of the data; and
stopping, when the transfer time measured at the measuring reaches a predetermined time, transferring the data stored in the memory.

11. A method of controlling data transfer for a direct-memory-access transfer apparatus that transfers data stored in a memory to other apparatus, the method comprising:
receiving, from the memory, an enabling signal relating to presence or absence of data to be stored in the memory; and
instructing, while the enabling signal is received at the receiving, to transfer the data stored in the memory.

12. The transfer control method according to claim 11, further comprising:
measuring transfer time of the data; and
stopping, when the transfer time measured at the measuring reaches a predetermined time, transferring the data stored in the memory.
